(19) United States
(12) Patent Application Publication
(10) Pub. No.: US 2008/0271366 A1
(43) Pub. Date: Nov. 6, 2008

(54) Composite tube having drip irrigation applications

(75) Inventors: Hugh A. Thompson, Fairfield, OH (US); Thomas R. Kruer, Erlanger, KY (US)

Correspondence Address: Jim Blackwood, 9406 Gunpowder Rd., Florence, KY, 41042, US

(73) Assignee: Toh Products LLC, Edgewood, KY (US)

(21) Appl. No.: 11/821,720

(22) Filed: Jun. 25, 2007

Related U.S. Application Data
(60) Provisional application No. 60/816,369, filed on Jun. 26, 2006.

(51) Int. Cl. A01G 7/06; F16L 55/00; A01G 25/00

(52) U.S. Cl. 47/9; 285/5; 47/48.5

(57) ABSTRACT

A composite tube having alternating porous and non-porous sections for the purpose of conserving water and fertilizer. An easily-manufactured drip irrigation mat incorporating this composite tube so as to provide an irrigated, weed-free, highly-supportive growing environment for both commercial and residential plants as single units, or as one-dimensional rows. A patchwork assembly of multiple drip irrigation mats and non-irrigating mulch to treat two-dimensional beds.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

This invention relates to drip irrigation and weed suppression for promoting the growth and health of desirable plants.

More specifically, the invention relates to a multi-functional product consistently supplying irrigation fluid to the root zones of desirable plants at low rates and with little runoff by a composite porous soaker hose while simultaneously suppressing growth of weeds and undesirable plants by an attached synthetic mulch sheet.

2. Description of Related Art Including Information Disclosed Under 37 CFR 1.97 and 37 CFR 1.98

This multi-function product, a relatively new concept in plant husbandry, has unique and challenging requirements. For optimum plant growth, while avoiding contaminating runoff, very low rates of irrigation flow to the plant are desirable. The flow application needs to be uniform around the plant despite sloping soil topography, which uniformly generally requires significant exit resistance. And the product preferably has good puncture resistance to prevent damage by thirsty insects. Prior art devices fail to meet these objectives and are less than fully successful.

Regarding irrigation mats, Popa (U.S. Pat. No. 3,302,323) employs plastic sheet-like material combined with conduits containing orifice openings oriented at 45 degrees relative to fluid flow in the conduits.

Dinur (DE 4408556) utilized a film of plastic material having holes for plants and an integral water duct containing pressure reducing elements for droplet discharge.

Carefree Gardner, Inc. (patent pending, http://carefreegardener.com/) offers the “Watering Weedless Wonder™”, a heavy duty polypropylene mat with soaker hose woven in.

Kruer and Thompson (U.S. Pat. No. 6,996,932 B2 and U.S. Pat. No. 6,997,402 B2) provide unitized drip irrigation mats having at least two polymeric material layers selectively bonded together to define fluid-conveying passageways.

Regarding porous tubing, Prassas et al (U.S. Pat. No. 5,069,388) use porous and non-porous pipe in combination wherein the soaker hose is designed for a flow rate which will balance that of point source emitters fed by the non-porous tubing.

Bard et al (U.S. Pat. No. 5,131,597) use an irrigation system combining porous and non-porous tubing with a pressure-reducing flow control fitting connecting them.

Youval et al (U.S. Pat. No. 4,182,582) discloses a tube with one or more longitudinal porous streaks where the remaining part of the circumference is nonporous.

Hoover (U.S. Pat. No. 6,260,769 B1) discloses a soaker hose having liquid barriers disposed concentrically outside a portion of the soaker hose and which barriers are axially moveable.

Mackenzie Nursery Supply Inc. offers a “pressure compensated dribble ring” with a drip emitter attached upstream to limit total flow (ww.mnsinc.cc).

### BRIEF SUMMARY OF THE INVENTION

This invention involves a composite tube having axially-alternating porous and non-porous sections suitable, for example, for drip irrigation of desirable plants. It also includes a weed-suppressing drip irrigation mat utilizing this tube. Used for drip irrigation, the porous sections emit irrigation fluid while non-porous sections transport fluid to the porous sections. The connections between sections are preferably made with Integral Tubing Connectors, for which a provisional patent application is being filed concurrently.

The composite tube of this invention is an improvement over prior art porous tubes or “soaker hoses” in that it provides local or point-source irrigation which conserves and concentrates water at the root zone, especially for widely-spaced plants. Further it provides designs of very low total flow through minimizing the fraction of total length which is porous. These low rates allow small diameters (for example, 1/16 inch inside diameter) for economy and for flexibility without kinking. The novel Integral Tubing Connectors provide very low cost and very simple manufacture. The flow resistance of the porous emitter sections provides equal output rates at multiple emitters around the plant regardless of ground slope or unevenness, unlike prior art tubes.

These same improvements also accrue to the drip irrigation mat based on this composite tube. Further, the mat can be fabricated from components by simple steps, including high-manual and “Intermediate Technology”—type operations. Similarly, customized designs are easily fabricated. The mat includes the option of weighted edges for anchoring against the wind.

The drip irrigation mat of the present invention is well-suited for container-grown plants, and is readily adapted to multi-plant rows. In additional it is also well-suited to covering sizeable areas such as landscaped beds by use of a patchwork layout of multiple mats wherein intermediate areas are covered with standard sheet mulch for weed prevention.

Thus an overall objective of this invention is to provide a very positive growing environment for both commercial and residential plants, including drip irrigation and run-off control combined with non-chemical elimination of competing weeds.

It is a further objective of this invention to provide this growing environment to single plants, rows of plants, and two dimensional arrays of widely-spaced plants.

It is a further objective to conserve water and fertilizer by dispensing these at very low rates and only to the root zone of each plant, and further, applying these uniformly despite sloping ground.

It is a further objective to provide puncture or insect bite resistance via the relatively thick-walled tubes and also to provide wind resistance to the mat via weighted edges.

It is a still further objective to provide these benefits in a low-cost, easily-produced product amenable to production by “Intermediate Technology” methods.

It is a still further objective to provide these as a combination of benefits not previously obtainable.

### BRIEF DESCRIPTION OF THE SEVERAL VIEWS OF THE DRAWINGS

FIG. 1 is a cross-sectional view of a typical portion of the composite tube of the present invention.

FIG. 2 is a perspective view of a drip irrigation mat of the present invention applied to a single plant with a partial cutaway to show the composite tube.

FIG. 3 is a perspective view of a drip irrigation mat of the present invention configured for a row of widely-spaced plants.

FIG. 4 is a schematic view of a landscaped bed in which individual drip irrigation mats are applied in a patchwork fashion with non-irrigating, weed-blocking mulch sheets between.

### DETAILED DESCRIPTION OF THE INVENTION

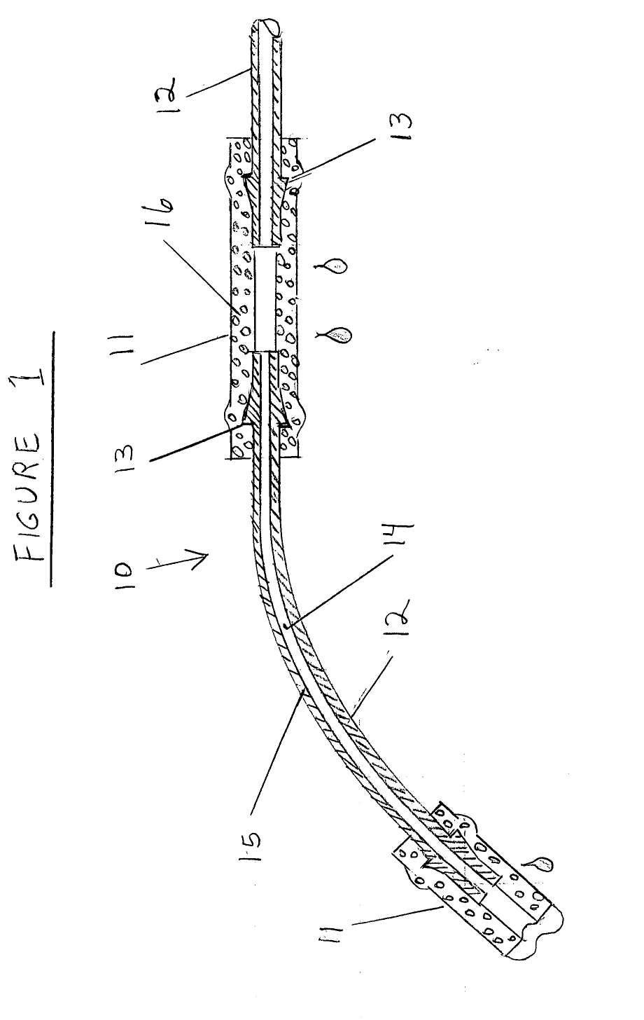

FIG. 1 shows a cross-sectional view 10 of a typical segment of the composite tube. The principle elements in this simple structure are the porous tube emitters 11, the non-porous supply tubes 12, and the Integrated Tubing Connectors (ITC) 13 which are integral with the tubes 12.

Along with its porosity, the length of the porous tube 11 is readily adjusted in design and manufacture to give a variety of drip rates. Likewise, the length of the non-porous tube 12 is readily adjusted in design to provide the desired emitter spacing. The ITC is integrally pre-formed on the tubing ends, and without adding extra parts provides a tight, self-locking, slip-together connection.

Because of efficient low flow rates, the inside diameter of the tubes can be unusually small. This in turn allows the tubes to bend sharply without kinking or pinching off. With a typical 1″-2″ porous length every foot, an inside diameter 14 for the non-porous tube of as little as 1/16″ is preferred but not mandatory. The walls 15 and 16 can be relatively-heavy for immunity for puncture by thirsty insects.

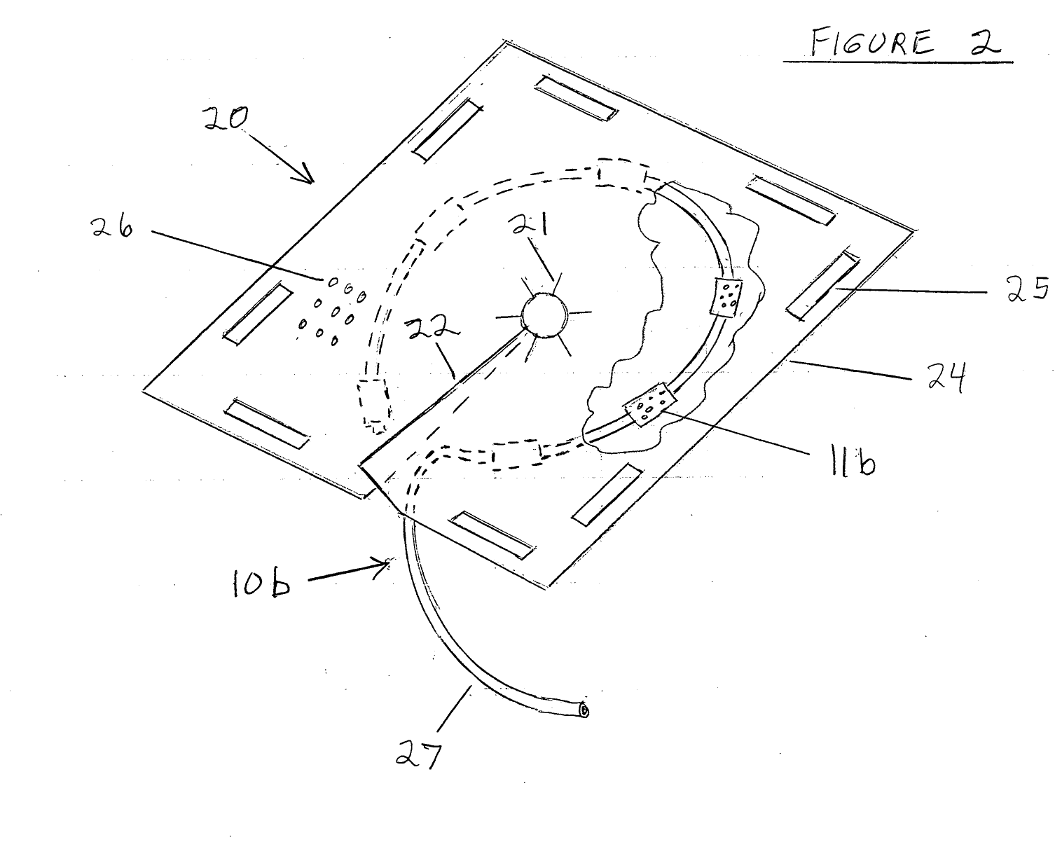

The application of the composite tube to irrigating a single plant is the subject of FIG. 2. In the drip irrigation mat 20, the tube 10b with porous emitters essentially encircles the plant for which an expandable plant opening 21 and an installation seam 22 are provided.

The mat body 24 is an ultra-violet-resistant sheet material sized and shaped to generally cover the area above the plant root zone. It may include appropriate optical properties for reflection or absorption of various wavelengths. Sheet materials may include polymeric film, non-woven or woven fabrics, paper, foam or combinations of these. Supply tube 27 is an extension of the composite tube. Optional aeration holes 26 are provided. Optional weighting elements 25 may be attached, including sand-filled pouches, inexpensive ceramic strips, or non-toxic waste materials. Additionally, the drip irrigation mat may optionally be preceded in its flow path by a pressure-reducing device. Rates of as little as 0.1 gallon per hour per plant can be achieved.

The methods of assembly of the mat of FIG. 2 from conventional materials will be apparent to those skilled in the art and from referral to the ITC application. The separate elements, including the composite tube, the sheet, and the weights are attached to each other by known techniques and materials (not shown) including plastic welding, heat sealing, hot melt adhesive, pressure-sensitive adhesive, sewing, laser welding, and the like. In general, durable materials and methods are used to provide for multi-season, multi-year use.

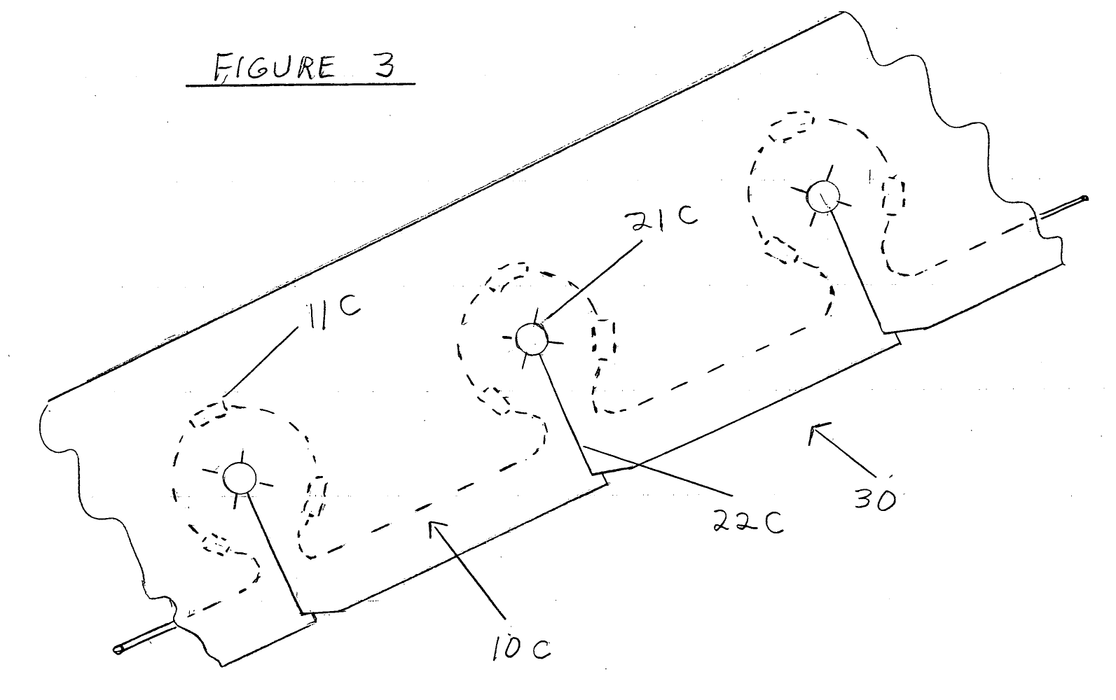

FIG. 3 illustrates the drip irrigation mat 30 applied to a row of widely-spaced plants. The versatile design of the composite tube 10c easily enables large unirrigated spaces to be left where there are no plants, thus conserving water and fertilizer and minimizing contaminated runoff.

Multiple expandable plant openings 21c and installation seams 22c provide for multiple plants. The emitters 11 are each plant opening 21c are spaced sufficiently close together to provide essentially-uniform application of irrigation fluid to the root zone.

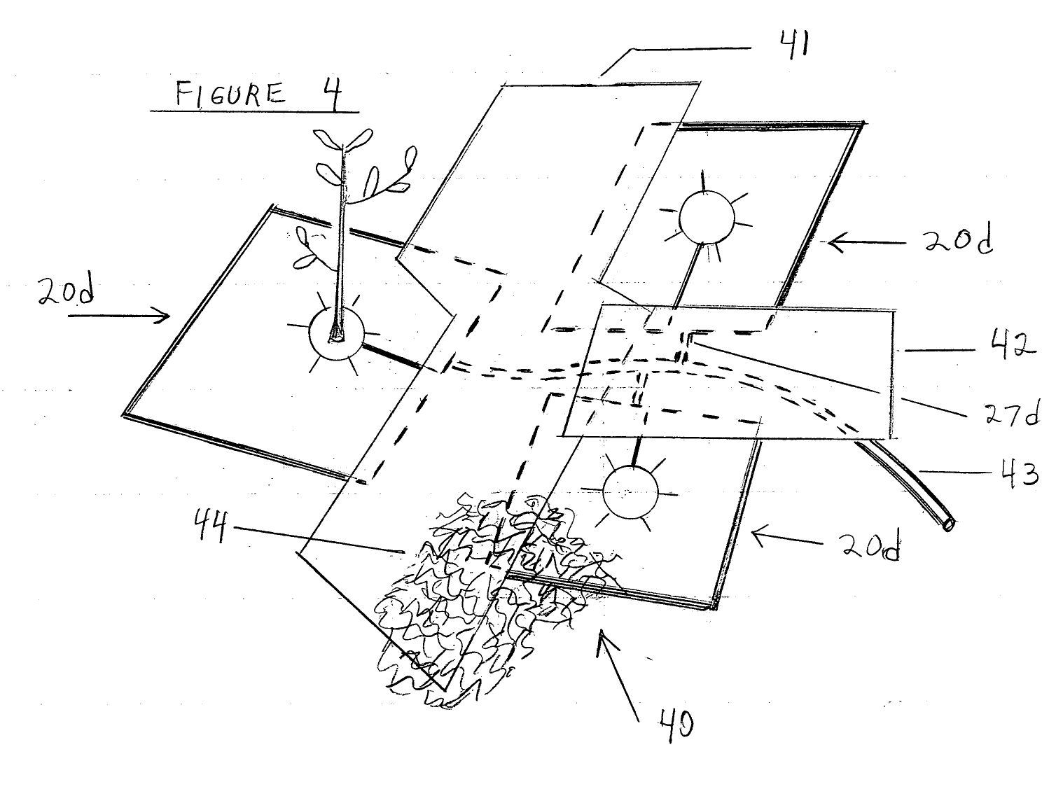

FIG. 4 is a schematic view of three drip irrigation mates 20d applied to serve a two-dimensional plant arrangement such as a landscaped bed. Gaps between the three drip irrigation mates 20d are covered for weeds suppression by strips of standard, non-irrigating synthetic weed-barrier mulch. Strip 41 has been trimmed to fit the required space, while strip 42 is a rectangle. Underneath the mulch sheets, the mat supply tubes 27d are fed by a common main supply hose 43. At thick layer of attractive particulate mulch 44 is used to completely cover the finished assembly 40.

We claim:

1. A composite tube comprised of porous tubing and non-porous tubing in alternating axial sections, which sections are connected and are in unrestricted fluid communication with each other, said porous tubing sections being fluid-emitting and said non-porous tubing sections being non-emitting of fluid.

2. The composite tube of claim 1 wherein the connections are made by Integrated Tubing Connectors.

3. The composite tube of claim 1 wherein the tube is preceding by pressure-reducing device.

4. The composite tube of claim 1 wherein said composite tube when operating at 10 psi internal pressure emits irrigation water at a rate averaged over its length of 0.25 gallons per hour per foot of length or less.

5. The composite tube of claim 1 wherein the ratio of non-porous section length to adjacent porous section length is at least four.

6. A multi-functional, puncture-resistant drip irrigation mat which includes a composite tube comprised of porous tubing and non-porous tubing in alternative axial sections, which sections are connected and are in unrestricted fluid communication with each other, said porous tubing sections being fluid-emitting and said non-porous tubing sections being non-emitting of fluid, said composite tube being attached to a synthetic mulch sheet to form a drip irrigation mat, said mat being sized and shaped to cover an area immediately around at least one plant.

7. The drip irrigation mat of claim 6 having an opening in which the plant extends therethrough.

8. The drip irrigation mat of claim 7 including an installation seam extending from said opening to an outer edge of the mat.

9. The drip irrigation mat of claim 6 wherein uniform output rates are obtained at multiple locations around the at least one plant irrespective of ground slope or contour around the at least one plant.

10. The drip irrigation mat of claim 6 including integral weighted or sand-filled regions disposed about the mulch sheet.

11. The drip irrigation mat of claim 6 wherein the mulch sheet is comprised of a polymeric film, a non-woven, a woven fabric, a foam, paper, or a combination of these.

12. A patchwork assembly of multiple interconnected drip irrigation mats wherein each mat surrounds, irrigated, and prevents weeds on a single plant or plant group, while the spaces between mats are covered by non-irrigating, weed-suppressing synthetic mulch.

13. The patchwork assembly of claim 12 covered by particulate mulch comprised of bark, stone, chips, or other attractive materials.
